(19) United States
(12) Patent Application Publication
(10) Pub. No.: US 2026/0321030 A1
(43) Pub. Date: Oct. 15, 2026

(54) SUBTITLE DETECTION DEVICE AND SUBTITLE DETECTION METHOD

(71) Applicant: REALTEK SEMICONDUCTOR CORPORATION, Hsinchu (TW)

(72) Inventors: Kang-Yu Liu, Hsinchu (TW); Chia-Wei Yu, Hsinchu (TW); Ju-Chun Wu, Hsinchu (TW)

(21) Appl. No.: 19/644,190

(22) Filed: Apr. 10, 2026

(30) Foreign Application Priority Data
Apr. 14, 2025 (TW) 114114088

(51) Int. Cl. G06V 20/62; G06F 40/58; G06V 30/19

(52) U.S. Cl. CPC G06V 20/635; G06F 40/58; G06V 30/19093

(57) ABSTRACT

A subtitle detection device includes an image processing circuit, a language recognition circuit, an audio detection circuit, a language conversion circuit, and a similarity comparison circuit. The image processing circuit performs a text detection on an image to generate a first text region of the image. The language recognition circuit performs a language recognition on the first text region to generate a first image text. The audio detection circuit performs a speech recognition on an audio to generate an audio text. If the first image text and the audio text are different language types, the language conversion circuit converts the first image text and the audio text into the same language type. The similarity comparison circuit compares the first image text and the audio text to generate a first similarity data. If a value of the first similarity data is larger than a threshold, the image includes a subtitle.

### BACKGROUND OF THE INVENTION

### 1. Field of the Invention

The present disclosure relates to a subtitle detection device and a subtitle detection method, especially to a subtitle detection device and a subtitle detection method that effectively detect images to obtain subtitles.

### 2. Description of Related Art

A video includes audio information and image information. Most existing automatic language detection devices adopt Automatic Speech Recognition (ASR) technology. Therefore, the automatic language detection devices process only the audio information and ignore the image information in the video. However, the image information in the video can also assist in determining certain language information or proper nouns.

### SUMMARY OF THE INVENTION

In some aspects, an object of the present disclosure is to, but not limited to, provides a subtitle detection device and a subtitle detection method that makes an improvement to the prior art.

An embodiment of a subtitle detection device includes an image processing circuit, a language recognition circuit, an audio detection circuit, a language conversion circuit, and a similarity comparison circuit. The image processing circuit performs a text detection on an image to generate a first text region of the image. The language recognition circuit performs a language recognition on the first text region to generate a first image text. The audio detection circuit performs a speech recognition on an audio to generate an audio text. If the first image text and the audio text are different language types, the language conversion circuit converts the first image text and the audio text into the same language type. The similarity comparison circuit compares the first image text and the audio text to generate a first similarity data, wherein if a first value of the first similarity data is larger than a threshold, the image includes a subtitle.

An embodiment of a subtitle detection method includes: performing a text detection on an image to generate a first text region of the image; performing a language recognition on the first text region to generate a first image text; performing a speech recognition on an audio to generate an audio text; converting the first image text and the audio text into the same language type if the first image text and the audio text are different language types; comparing the first image text and the audio text to generate a first similarity data; and determining that the image includes a subtitle if a first value of the first similarity data is larger than a threshold.

Technical features of some embodiments of the present disclosure make an improvement to the prior art. The subtitle detection device and the subtitle detection method of the present disclosure not only perform a speech recognition on an audio to obtain corresponding text, but also effectively detect images to obtain subtitles in the images. Therefore, the text obtained from the audio and the subtitles obtained from the images can subsequently be used to accurately perform an automatic language detection.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a subtitle detection device of the present disclosure.

FIG. 2 shows an embodiment of a flow diagram of a subtitle detection method of the present disclosure.

FIG. 3 shows an embodiment of a subtitle detection device of the present disclosure.

FIG. 4 shows an embodiment of a flow diagram of a subtitle detection method of the present disclosure.

### DETAILED DESCRIPTION OF THE PREFERRED EMBODIMENTS

To address the issue that conventional automatic language detection devices rely only on automatic speech recognition (ASR) technology and ignore subtitles in images, the present disclosure provides a subtitle detection device and a subtitle detection method, which are described in detail below.

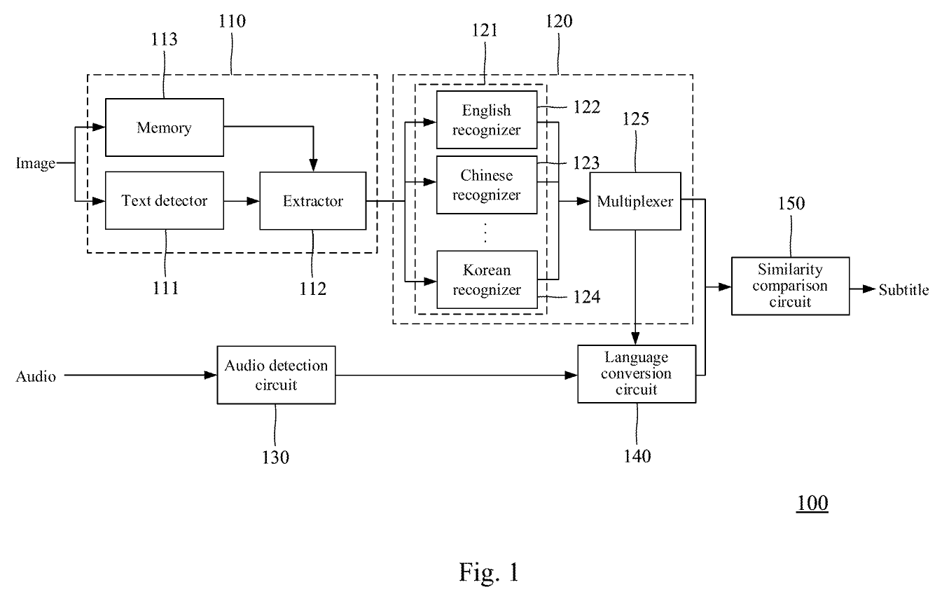

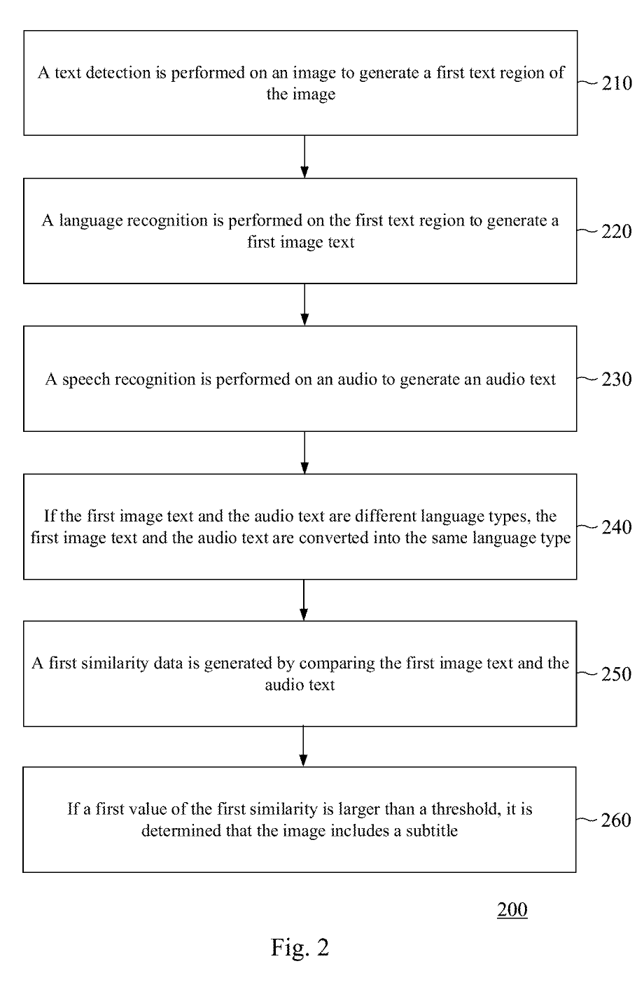

FIG. 1 shows an embodiment of a subtitle detection device 100 of the present disclosure. As shown in the figure, the subtitle detection device 100 includes an image processing circuit 110, a language recognition circuit 120, an audio detection circuit 130, a language conversion circuit 140, and a similarity comparison circuit 150. In order to facilitate understanding of the operation of the subtitle detection device 100, reference is also made to FIG. 2. FIG. 2 shows an embodiment of a flow diagram of a subtitle detection method 200 of the present disclosure.

Referring to step 210 of FIG. 2, a text detection is performed on an image to generate a first text region of the image. For example, referring to FIG. 1, the image processing circuit 110 of the present disclosure includes a text detector 111, an extractor 112, and a memory 113. First, the image is input to the text detector 111 and the memory 113. Next, the text detector 111 performs a text detection on the image to generate a position (e.g., coordinate) of text in the image. The extractor 112 obtains the image from the memory 113, and extracts the first text region in the image according to the position (e.g., coordinate).

For example, if the text is located at a lower portion of the image, the text detector 111 performs a text detection on the image to generate corresponding coordinates of the lower portion of the image, and then the extractor 112 extracts the text region at the lower portion of the image according to the corresponding coordinates. In addition, if the text is located at an upper portion of the image, the extractor 112 finally extracts the text region at the upper portion of the image, and so on. Therefore, regardless of where the text is located in the image, the image processing circuit 110 of the present disclosure is capable of extracting the corresponding text region in the image.

In some embodiments, the text detector 111 may adopt a Differentiable Binarization Network (DBNet), and in order to achieve real-time detection, a backbone network may adopt a MobileNetv3 architecture. In some embodiments, the extractor 112 may be implemented as a crop hardware (Crop HW).

Referring to step 220 of FIG. 2, a language recognition is performed on the first text region to generate a first image text. For example, referring to FIG. 1, the language recognition circuit 120 of the present disclosure includes a language recognizer 121 and a multiplexer 125. The language recognizer 121 performs a language recognition on the first text region to generate a plurality of image texts and a plurality of probabilities corresponding to the plurality of image texts. The multiplexer 125 selects the first image text from the plurality of image texts according to a highest probability among the plurality of probabilities.

For example, the language recognizer 121 may include recognizers for multiple languages, such as an English recognizer 122, a Chinese recognizer 123, a Korean recognizer 124, and so on. These recognizers may sequentially perform recognition and prediction on the text region to generate English text with a probability of 90%, Chinese text with a probability of 5%, Korean text with a probability of 1%, and so on. The multiplexer 125 selects the English text according to the highest probability of 90%, and stores English (i.e., the language type) and the English text for subsequent use. In some embodiments, the language recognizer 121 may adopt an SVTR (Swin Transformer for Text Recognition) architecture, and by adopting the transformer architecture, more accurate text recognition performance can be achieved.

Referring to step 230 of FIG. 2, a speech recognition is performed on an audio to generate an audio text. For example, referring to FIG. 1, the audio detection circuit 130 of the present disclosure performs a speech recognition on an audio to generate an audio text, such as Chinese, English, Korean, and so on. In some embodiments, the audio detection circuit 130 may be an Automatic Speech Recognition (ASR) circuit. Furthermore, the audio detection circuit 130 may adopt a speech recognition model developed by OpenAI, namely Whisper, to simultaneously perform speech recognition and language type recognition.

Referring to step 240 of FIG. 2, if the first image text and the audio text are different language types, the first image text and the audio text are converted into the same language type. For example, referring to FIG. 1, the language conversion circuit 140 of the present disclosure determines whether the first image text generated by the language recognition circuit 120 and the audio text generated by the audio detection circuit 130 are the same language type. Assuming that the language recognition circuit 120 generates English text while the audio detection circuit 130 generates Chinese text, the language conversion circuit 140 determines that the English text and the Chinese text are different language types. At this time, the language conversion circuit 140 converts the English text and the Chinese text into the same language type. For example, the language conversion circuit 140 converts both texts into English text, or the language conversion circuit 140 converts both texts into Chinese text. In some embodiments, the language conversion circuit 140 may adopt a No Language Left Behind (NLLB) technique, which is capable of translating multiple languages.

Referring to step 250 of FIG. 2, a first similarity data is generated by comparing the first image text and the audio text. Referring to step 260 of FIG. 2, if a first value of the first similarity data is larger than a threshold, it is determined that the image includes a subtitle. For example, referring to FIG. 1, after the language conversion circuit 140 converts texts into the same language type, the similarity comparison circuit 150 of the present disclosure can compare the image text and the audio text to generate a similarity data. In some embodiments, the similarity comparison circuit 150 can adopt a string compare approach, a word network, or a neural network approach (inputting two strings into a language model network to compare distance) to obtain the similarity data. Subsequently, the similarity comparison circuit 150 can determine whether the value of the similarity data is larger than the threshold. If the value of the similarity data is larger than the threshold, it represents that there is the subtitle in the image, and the above subtitle is subsequently output for subsequent applications. As can be known from the above embodiments, the subtitle detection device 100 and the subtitle detection method 200 of the present disclosure, in addition to performing a speech recognition on an audio to obtain an audio text, can also effectively perform a detection on an image to obtain a subtitle in the image. Therefore, the text obtained from the audio and the subtitle obtained from the image can subsequently be used to accurately perform an automatic language detection.

In some embodiments, the similarity comparison circuit 150 can adopt a string compare approach, such as the Rabin-Karp algorithm, or alternatively, the similarity comparison circuit 150 can adopt a neural network approach, such as Word Embedding, more specifically, such as a text-embedding developed by OpenAI.

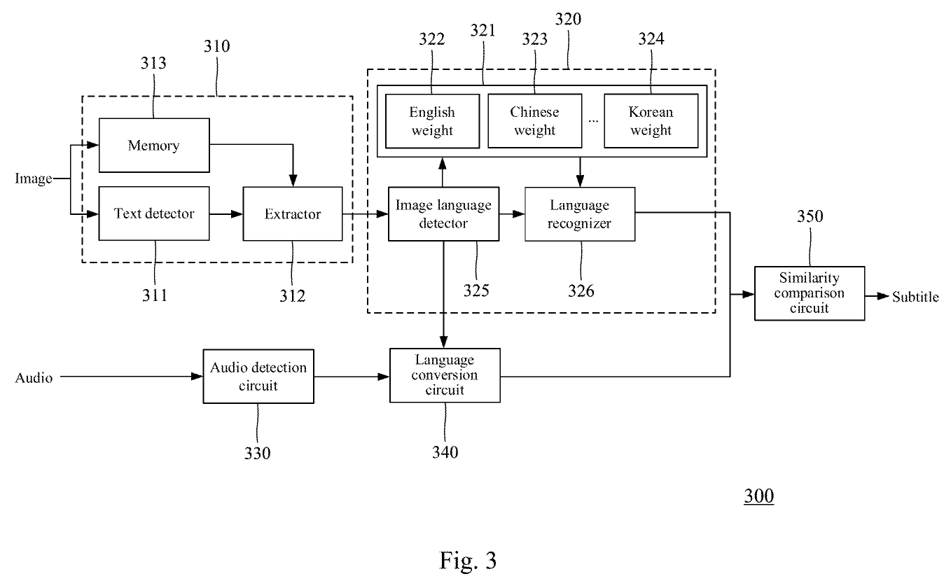

FIG. 3 shows an embodiment of a subtitle detection device 300 of the present disclosure. Compared with the subtitle detection device 100 of FIG. 1, the difference of the subtitle detection device 300 of FIG. 3 lies in a language recognition circuit 320, which is described as follows.

As shown in FIG. 3, the language recognition circuit 320 of the present disclosure includes a language weight generator 321, an image language detector 325, and a language recognizer 326. In addition, the language weight generator 321 includes an English weight 322, a Chinese weight 323, a Korean weight 324, and so on. For example, the image language detector 325 can perform a language detection on a text region of an image to generate an image language type. Subsequently, the language weight generator 321 can generate a language weight according to the image language type. Next, the language recognizer 326 can perform a language recognition on the text region to generate an image text according to the language weight.

Assume that, after the image language detector 325 performs a language detection on the text region of the image, it detects that the text in the text region is English. Subsequently, the language weight generator 321 can generate the English weight 322 according to English. Next, the language recognizer 326 can perform a language recognition on the text region according to the English weight 322 to generate the English text. It should be noted that, other than the language recognition circuit 320, operations of remaining circuits of the subtitle detection device 300 of FIG. 3 are similar to corresponding circuits in the subtitle detection device 100 of FIG. 1, and for making the specification of the present disclosure concise, details thereof are not repeated herein.

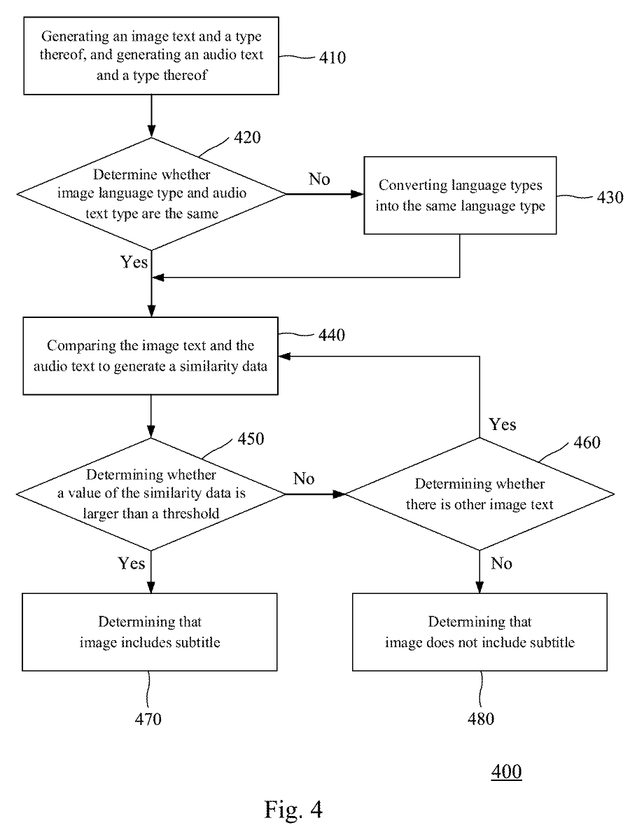

FIG. 4 shows an embodiment of a flow diagram of a subtitle detection method 400 of the present disclosure. Referring to step 410 of FIG. 4, in some embodiments, the image processing circuit 110 of the present disclosure can perform a text detection on an image to generate a text region of the image. Subsequently, the language recognition circuit 120 performs a language recognition on the text region to generate an image text and a type thereof. In addition, the audio detection circuit 130 of the present disclosure can perform a speech recognition on an audio to generate an audio text and a type thereof.

Referring to step 420 of FIG. 4, the language conversion circuit 140 of the present disclosure can determine whether an image language type and an audio text type are the same. Assume that the image language type is English and the audio text type is Chinese, and the language types of the two are not the same, then step 430 is performed. The language conversion circuit 140 of the present disclosure can convert the image language type and the audio text type into the same language type, such as the language conversion circuit 140 converting the above texts into English texts, or the language conversion circuit 140 converting the above texts into Chinese texts. Subsequently, step 440 is performed. In addition, assume that the image language type is English and the audio text type is English, and the language types of the two are the same, then step 440 is directly performed.

Referring to step 440 of FIG. 4, the similarity comparison circuit 150 of the present disclosure can compare the image text and the audio text to generate a similarity data. Subsequently, step 450 is performed, and the similarity comparison circuit 150 of the present disclosure can determine whether a value of the similarity data is larger than a threshold. If the value of the similarity data is larger than the threshold, step 470 is performed, there is a subtitle in the image, and the above subtitle is output for subsequent applications. Conversely, if the value of the similarity data is not larger than the threshold, step 460 is performed, and it is continued to determine whether there is other image text, for example, the image processing circuit 110 can process the image and determine whether the image includes other image text.

If the image includes other image text, step 440 is performed. The similarity comparison circuit 150 of the present disclosure can again compare the other image text and the audio text to generate the similarity data. Subsequently, step 450 is again performed. The similarity comparison circuit 150 of the present disclosure can determine whether the value of the similarity data is larger than the threshold. If the image does not include other image text, step 480 is performed. The image of the present disclosure does not include a subtitle, and the subtitle detection method 400 ends.

It should be noted that, the subtitle detection methods 200, 400 of the present disclosure are not limited to being executed only by the subtitle detection devices 100, 300. In some embodiments, the subtitle detection methods 200, 400 can also be executed by a processor of an electronic component reading at least one instruction in a memory.

It should be noted that the present disclosure is not limited to the embodiments as shown in FIGS. 1 to 4, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The subtitle detection device and the subtitle detection method of the present disclosure not only perform a speech recognition on an audio to obtain corresponding text, but also effectively detect images to obtain subtitles in the images. Therefore, the text obtained from the audio and the subtitles obtained from the images can subsequently be used to accurately perform an automatic language detection.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically include transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A subtitle detection device, comprising:
an image processing circuit, configured to perform a text detection on an image to generate a first text region of the image;
a language recognition circuit, configured to perform a language recognition on the first text region to generate a first image text;
an audio detection circuit, configured to perform a speech recognition on an audio to generate an audio text;
a language conversion circuit, wherein if the first image text and the audio text are different language types, the language conversion circuit is configured to convert the first image text and the audio text into the same language type; and
a similarity comparison circuit, configured to compare the first image text and the audio text to generate a first similarity data, wherein if a first value of the first similarity data is larger than a threshold, the image comprises a subtitle.

2. The subtitle detection device of claim 1, wherein the image processing circuit comprises:
a text detector, configured to perform the text detection on the image to generate a position of a text in the image; and
an extractor, configured to extract the first text region of the image according to the position.

3. The subtitle detection device of claim 1, wherein the language recognition circuit comprises:
a language recognizer, configured to perform the language recognition on the first text region to generate a plurality of image texts and a plurality of probabilities corresponding to the plurality of image texts; and
a multiplexer, configured to select the first image text from the plurality of image texts according to a highest probability among the plurality of probabilities.

4. The subtitle detection device of claim 1, wherein the language recognition circuit comprises:
an image language detector, configured to perform a language detection on the first text region to generate an image language type;
a language weight generator, configured to generate a language weight according to the image language type; and
a language recognizer, configured to perform the language recognition on the first text region according to the language weight to generate the first image text.

5. The subtitle detection device of claim 1, wherein if the first value of the first similarity data is not larger than the threshold, the image processing circuit processes the image and determines whether the image comprises a second text region;
wherein if the image comprises the second text region, the language recognition circuit performs the language recognition on the second text region to generate a second image text; and
wherein the similarity comparison circuit compares the audio text with the second image text to generate a second similarity data, wherein if a second value of the second similarity data is larger than the threshold, the image comprises the subtitle.

6. A subtitle detection method, comprising:
performing a text detection on an image to generate a first text region of the image;
performing a language recognition on the first text region to generate a first image text;
performing a speech recognition on an audio to generate an audio text;
converting the first image text and the audio text into the same language type if the first image text and the audio text are different language types;
comparing the first image text and the audio text to generate a first similarity data; and
determining that the image comprises a subtitle if a first value of the first similarity data is larger than a threshold.

7. The subtitle detection method of claim 6, wherein performing the text detection on the image to generate the first text region of the image comprises:
performing the text detection on the image to generate a position of a text in the image; and
extracting the first text region of the image according to the position.

8. The subtitle detection method of claim 6, wherein performing the language recognition on the first text region to generate the first image text comprises:
performing the language recognition on the first text region to generate a plurality of image texts and a plurality of probabilities corresponding to the plurality of image texts; and
selecting the first image text from the plurality of image texts according to a highest probability among the plurality of probabilities.

9. The subtitle detection method of claim 6, wherein performing the language recognition on the first text region to generate the first image text comprises:
performing a language detection on the first text region to generate an image language type;
generating a language weight according to the image language type; and
performing the language recognition on the first text region according to the language weight to generate the first image text.

10. The subtitle detection method of claim 6, further comprising:
processing the image and determining whether the image comprises a second text region if the first value of the first similarity data is not larger than the threshold;
performing the language recognition on the second text region to generate a second image text if the image comprises the second text region;
comparing the audio text with the second image text to generate a second similarity data; and
determining that the image comprises the subtitle if a second value of the second similarity data is larger than the threshold.
